(19) United States
(12) Patent Application Publication
(10) Pub. No.: US 2008/0320513 A1
(43) Pub. Date: Dec. 25, 2008

(54) DYNAMIC CHANNEL SURFING GUIDE AND CUSTOMIZED TELEVISION HOME PAGE

(75) Inventors: Curtis G. Wong, Medina, WA (US); Dale A. Sather, Seattle, WA (US); Kenneth Reneris, Clyde Hill, WA (US); Thaddeus C. Pritchett, Edmonds, WA (US); Talal A. Batrouny, Sammamish, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/767,333

(22) Filed: Jun. 22, 2007

(51) Int. Cl. H04N 5/445

(52) U.S. Cl. 725/38

(57) ABSTRACT

The disclosure relates to an enhanced system and methodology of navigating video sources to determine video content to potentially view. Available video sources, such as individual television channels, not currently being viewed are monitored and analyzed, such as to determine if an advertisement is currently being presented. As a result of the content analysis and user preferences, the user is provided with a recommended subset of video sources to potentially view. User preferences can be explicitly indicated or inferred, such as based on a user's historical viewing habits. In addition, user preferences can be set for individual users or collective users, such as a combined mother and son “user.”

### TECHNICAL FIELD

This disclosure is related to enhancing the navigation of multiple video sources, such as enhancing the navigation of multiple television channels.

### BACKGROUND

The amount of video content available to viewers is increasing rapidly. Americans are no longer restricted to the major networks for most of their television viewing. In recent years, cable and satellite television has greatly increased the number of channels available to viewers. With the increase in number of channels offered, there has been a resulting explosion of channels that cater to particular niches. In addition, the number of different input sources, other than cable/satellite, has also increased significantly. As a result, viewers have trouble navigating video sources to find the video content that want to watch.

Conventional methods of navigating channels do not scale well as the number of channels increase and become cumbersome for viewers. For example, flipping through all the channels with the remote can take a significant amount of time. Channel guides are often used as an alternative so that a viewer can see listings for multiple channels at the same time. Thus, reducing the need to visit each channel. However, the guides are relatively static in the channels displayed, require time to see listings for all channels including ones that are unlikely to have content the viewer wants to watch and are often organized in orders dictated by someone other than the user, such as by channel number or channel name. Furthermore, channel guides assume that the scheduled main content of a channel is currently being presented and thus the channel guide is unchanged if other content (e.g., breaking news, a sporting event that went into overtime, commercials) is instead being currently presented on the channel.

Video content presentation devices have now also started to introduce the notion of favorite channels. Access to favorite channels can be then be optimized for the user. However, there are a number of drawbacks to using favorite channels. First, the user interface for setting favorites is often not easy to use for technology-challenged people. In addition, most of the time, favorites must be set on a device-wide basis, not a user-basis. Hence, individual family members cannot have their own favorites.

In addition, the conventional techniques fail to address navigating alternative video sources, such as local over the air channels, downloaded video content, or purchased/leased video content, such as a DVD.

The above-described deficiencies are merely intended to provide an overview of some of the problems of today's viewing techniques, and are not intended to be exhaustive. Other problems with the state of the art may become further apparent upon review of the description of various non-limiting embodiments of the invention that follows.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

According to one aspect of the invention, available video sources, such as individual television channels, not currently being viewed are monitored and analyzed, such as to determine if an advertisement is currently being presented. User preferences can be explicitly indicated or inferred, such as based on a user's historical viewing habits. As a result of the content analysis and user preferences, the user is provided with a recommended subset of video sources to potentially view. The recommended subset can be presented to a user in various manners, such as a homepage when the TV is initially turned on, in a small picture window when the channel the user is currently watching turns to a commercial, or dynamically rearranging the order in which video sources are navigated. In addition, user preferences can be set for individual users or collective users, such as a combined mother and son “user.”

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 illustrates a schematic block diagram of an exemplary viewing environment.

FIG. 2 depicts a block diagram of exemplary components of a channel navigation system according to one embodiment.

FIG. 3 depicts a block diagram of the artificial intelligence component according to one embodiment.

FIGS. 4A-4C depicts an example user interface for displaying recommendations.

FIG. 5 is an example user interface for explicitly specifying user preferences.

FIG. 6 depicts an exemplary flow chart of a content recommendation method.

FIG. 7 is an exemplary flow chart of analyzing the user's viewing history to infer user preferences.

FIG. 8 is an exemplary flow chart of performing content analysis.

FIG. 9 illustrates a block diagram of a computer operable to execute the disclosed architecture.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Video sources can, but are limited to, include individual channels on a cable/satellite lineup, local stations received over the air and video input sources (e.g., DVD players, camcorders). Some of the content from the alternative video input sources can be purchasable video content, such as DVDs, VCR tapes, and downloaded video content.

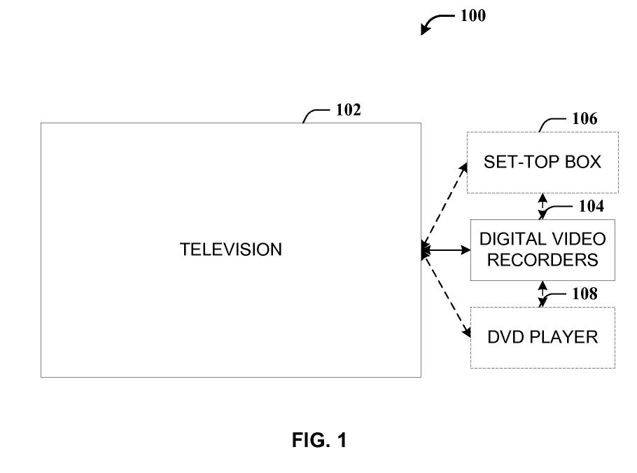

Referring now to FIG. 1, a block diagram of an operating environment 100 is illustrated. The example environment contains a television 102, a set-top box 106 (e.g., a cable box), a digital video recorder 104, and a DVD player. The television 102 presents the video content. In one embodiment, the digital video recorder 104 contains the enhanced navigation system. However, in other embodiments, the system and methods can be implemented as part of the television, a set-top box, or media center personal computer.

One will appreciate that this is exemplary and more generally any presentation device (e.g., a monitor, projector, computer screen) and other video inputs (e.g., VCR, camcorder, computer for purchased downloadable content) can be utilized in other embodiments.

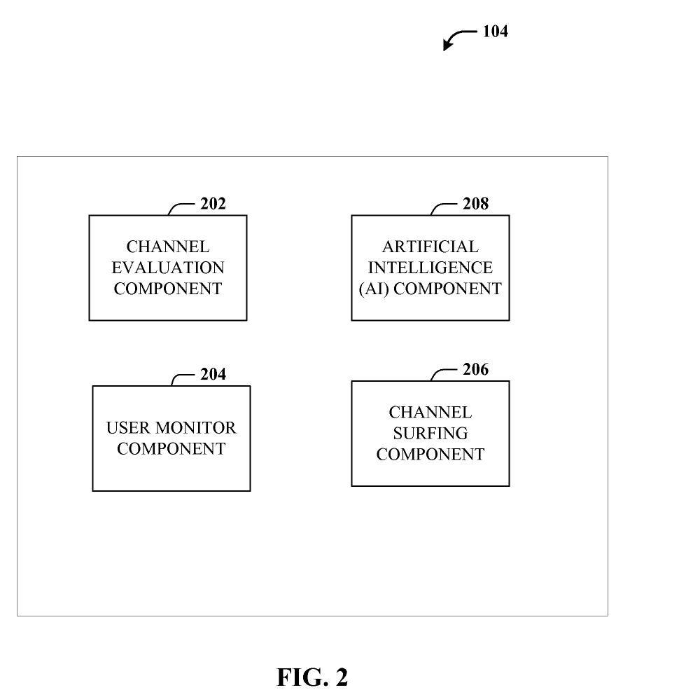

Referring to FIG. 2, a block diagram of the channel navigation system according to one embodiment is illustrated. The illustrated system contains a channel evaluation component, an artificial intelligence (AI) component 208, a user monitor component 204, and a channel surfing component 206. The channel evaluation component 202 continuously monitors and analyzes at least a subset of available video sources, such as television stations. The component can, for example, detect whether a commercial or other non-scheduled content is currently being broadcast on that source and set the resulting recommendation accordingly. The user monitor component 204 allows the user to explicitly set user preferences, as well as records the user's viewing history to supply to the artificial intelligence component 208. The user monitor can also monitor the user's state and use that to recommend programs or automatically perform actions. The artificial intelligence component 208 determines the recommended video sources based on user preferences and the content analysis performed by the channel evaluation component 202. The artificial intelligence component 208 can in some embodiments automatically perform various actions, such as changing channels during commercial breaks or automatically turning the TV at an appropriate time to watch a television program. Finally, the channel surfing component presents the recommendations to the user. The recommendations can be displayed in various manners, such as on a customized home page for the user or on-screen during a commercial break in a program the user is watching. In other embodiments, the navigation when flipping channels is changed automatically to reflect the recommendations.

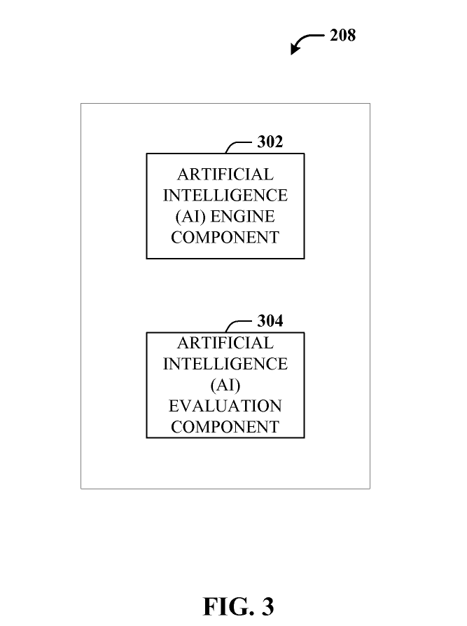

Referring to FIG. 3, an example block diagram of the artificial intelligence component 208 is depicted The AI engine component 302 can include an inference component (not shown) that can further enhance automated aspects of the AI component utilizing, in part, inference based schemes to facilitate inferring intended actions to be performed at a given time and/or state. The AI-based aspects of the invention can be effected via any suitable machine-learning based technique and/or statistical-based techniques and/or probabilistic-based techniques.

The artificial intelligence component 208 can employ various artificial intelligence based schemes for recommending programs based on the content analysis and user preferences. Specifically, artificial intelligence engine and evaluation components 302, 304 can be provided to implement the artificial intelligence component 208. Further, the artificial intelligence engine and evaluation components 302, 304 can be employed to facilitate automatic actions that it is inferred the user desires performed.

A classifier is a function that maps an input attribute vector, x=(x1, x2, x3, x4, xn), to a confidence that the input belongs to a class, that is, f(x)=confidence(class). The class can represent, for example, shows the user always watches, watches sometime, rarely watches, and never watches. Such classification can employ a probabilistic and/or statistical-based analysis (e.g., factoring into the analysis utilities and costs) to infer a recommended video source action for the user or to infer an action that a user desires to be automatically performed (e.g., changing the channel during a commercial break or toggling picture and picture).

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g. naïve Bayes, Bayesian networks, decision trees, and probabilistic classification models providing different patterns of independence can be employed. Classification as used herein also is inclusive of statistical regression that is utilized to develop models of priority.

As will be readily appreciated, the system can employ classifiers that are explicitly trained (e.g., via explicit user input) as well as implicitly trained (e.g., via the user's viewing history). For example, SVM's can be configured via a learning or training phase within a classifier constructor and feature selection module. In other words, the use of expert systems, fuzzy logic, support vector machines, greedy search algorithms, rule-based systems, Bayesian models (e.g., Bayesian networks), neural networks, other non-linear training techniques, data fusion, utility-based analytical systems, systems employing Bayesian models, etc. are contemplated and are intended to fall within the scope of the hereto appended claims.

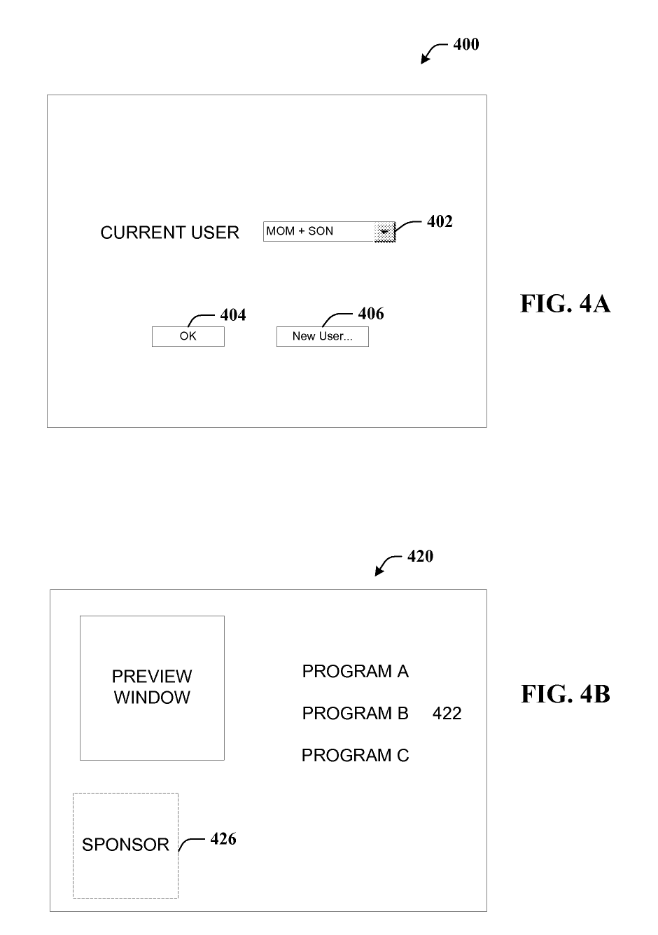

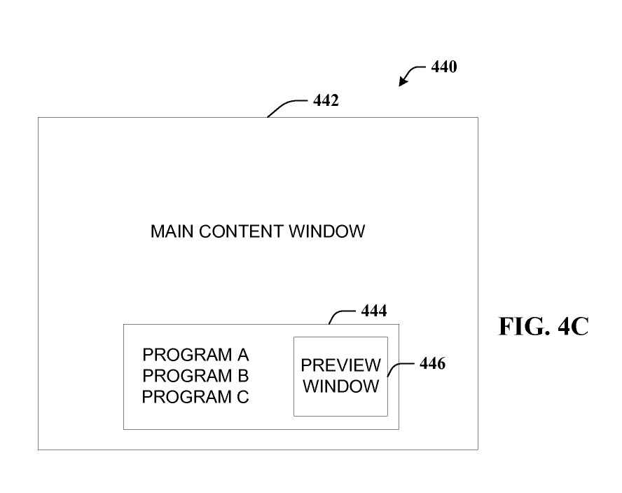

Referring to FIGS. 4A-4C, an example user interface 400 and 420 for display the recommendations. In particular, FIG. 4A, illustrates a user interface 400 to select a user. In this example, the user is selected from a drop-down list 402. The selected user is a collective user, meaning that it determines recommendations that are appropriate for two or more viewers. Collective users are helpful in situations such as parent/child or boyfriend/girlfriend to find programming that is appropriate to both people, rather than content that is selected only for a single viewer. In this example, content that is selected for the mother and the son will likely be family friendly television that appeals to males and females. One will also appreciate that in other embodiments a password can be used to protect a user's account. User-selectable control 404 allow the user to be identified and user-selectable control 406 allows a new user to be created.

FIG. 4B illustrates a user interface 420 displaying the recommendation to the user on a customized home page. The home page contains a listing of recommendations 422, a preview window 424, and optional sponsor advertising space 426. The listing of recommendations is dynamic and will change periodically, such as if an advertisement or other non-main video content is currently broadcasting on a particular station. Other information, such as information from the electronic program guide, about the recommended programs can be displayed in various embodiments. The preview window allows a preview of the recommended content be viewed before changing to it. A logo of a sponsor 426 can be displayed if the recommended content, for example, includes purchasable content, such as a downloadable movie. This home page can be displayed after the user is identified when the television is turned on and at other times, such as in place of the electronic program guide when the guide control is selected by the user.

FIG. 4C illustrates an alternative user interface 440 that is less intrusive and allows for quick navigation, such as during commercial breaks or after a television program has ended. The main content is displayed in the main content window 442 and the recommendations are displayed in a recommendation window 444 containing a preview window 446. The recommendation windows can be transparent or semitransparent. One skilled in the art can appreciate that although the programs are the same as in FIG. 4B, different programs can be recommended here based on the user state. For example, a user could be presented here with a choice to flip to a weather channel to view the weather during a commercial break, but can be presented at the same time recommendations for full shows if the customized home page were pulled up.

In other embodiments, recommendations can be presented in other ways, such as dynamically altering the channel lineup to place the recommended video sources first and less recommended one later in the lineup. This lineup is dynamic and can change as a result of non-main content being currently presented on the video source or based on the event that triggered the channel change (e.g. commercial break in content user was watching versus turning the television on).

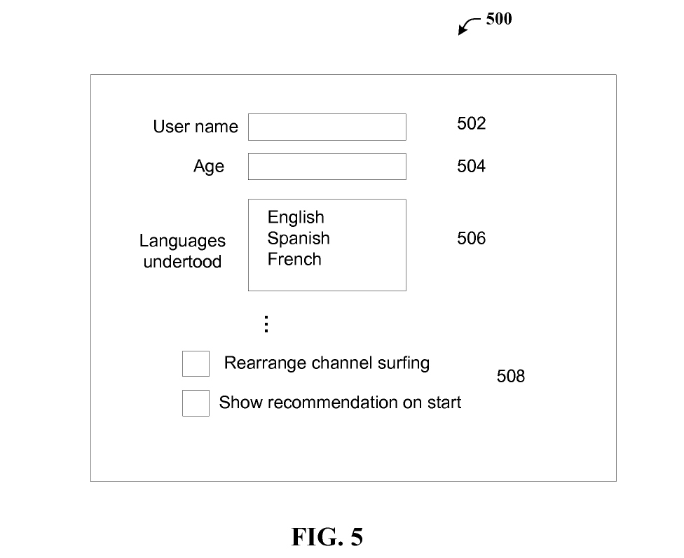

Referring to FIG. 5, an example user interface 500 is depicted for explicitly setting user preferences. The illustrated user preferences include a name for the user 502, age of the user 504, language understood 506, and preferences 508 related to displaying the recommendations. One will appreciate that any number of demographic attributes about the user or attribute about the user's presentation devices can be collected from the user beyond that illustrated. For example, sports teams the user roots for, times the user watches television, gender, occupation, education, etc. can also be collected about the user. Useful attributes about presentation devices can include channels of speakers, maximum resolution of the television, video formats (high definition vs. standard definition), etc. Information about a presentation device can be entered once for all users in some embodiments. Preferences 508 related to displaying recommendations can also exclude other video input sources, such as local over the air stations. Although not shown, a similar user interface can be presented to receive user settings for a collective user.

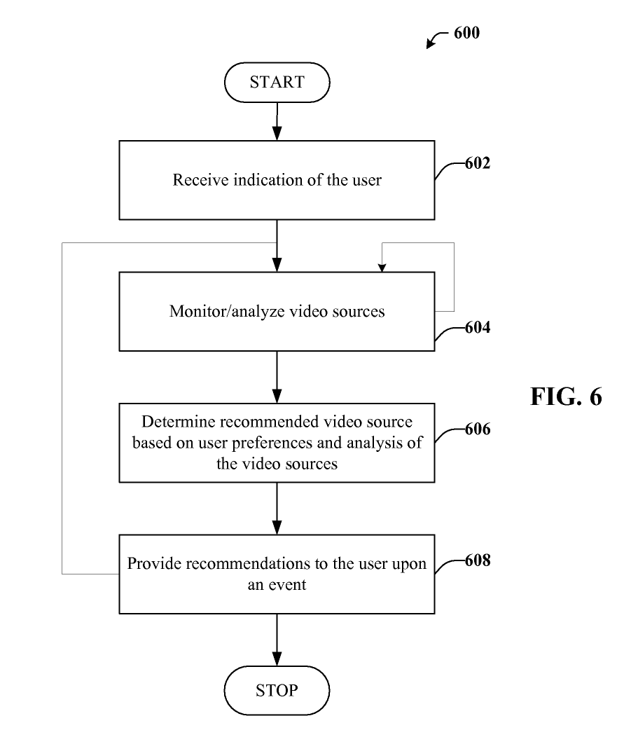

FIGS. 6-8 illustrate various methodologies in accordance with one embodiment. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media. Furthermore, it should be appreciated that although for the sake of simplicity an exemplary method is shown for use on behalf of a single user or analyzing a single channel, the method may be performed for multiple users or multiple channels.

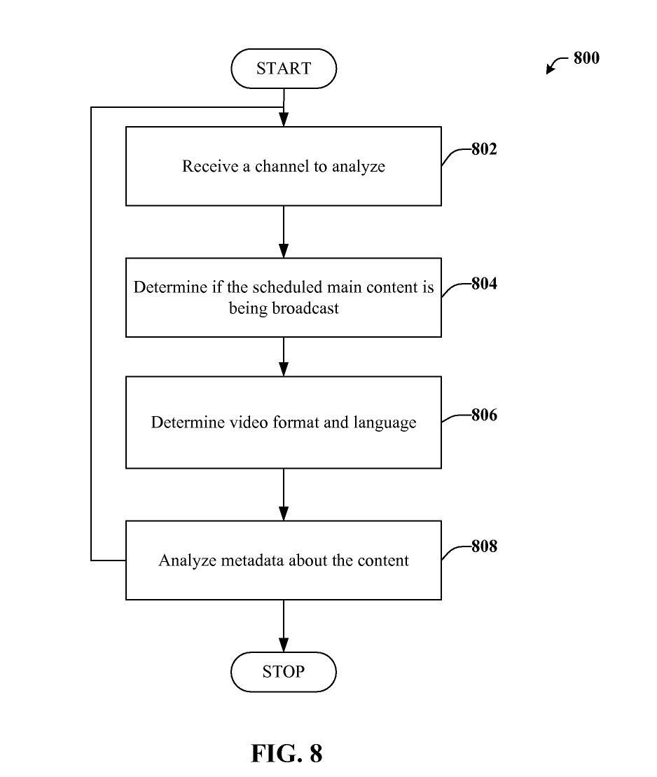

Referring now to FIG. 6, an exemplary method 600 of the content recommendation system. At 602, an indication is received of the current user. As previously mentioned, the user can be an individual viewer or a collective user. At 604, the available video sources are monitored and analyzed. Additional details about the analysis are depicted in FIG. 8. At 606, recommendations are determined based on user preferences, whether implicit or explicit, and the analysis of the video sources. At 608, the recommendations are provided to the user upon the occurrence of an event. By way of example, an event can include turning the television on, logging on a different user, a commercial break in the television program being watched, or the end of a television program or a movie.

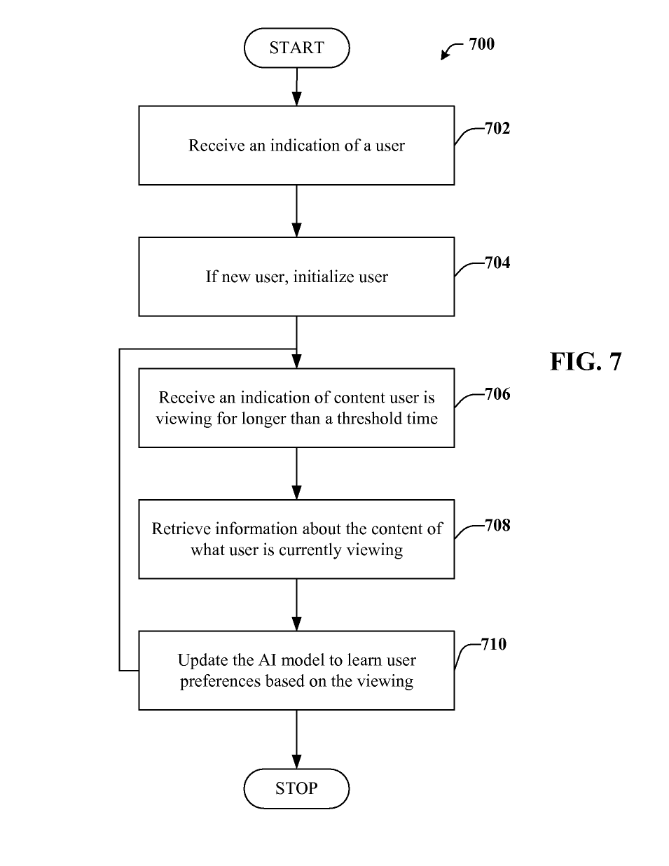

Referring now to FIG. 7, an exemplary method 700 is depicted of analyzing the user's viewing history to infer user preferences. At 702, an indication is received of a user. At 704, if the user is a new user, the new user is initialized. The initialization can include creating an initial AI model for the user and acquiring some explicit user preferences. In one embodiment, the explicit user preferences can be used to obtain a base AI model from a remote server (not shown) for the demographic group the user falls into. At 706, an indication is received of content the user is viewing. In order to prevent content being added to the AI model while a user is manually navigating channels, a time threshold (e.g., 30 seconds) can be utilized before the user is considered to be viewing the content. At 708, information is retrieved about the content the user is viewing. This information can include the channel number, genre, original air date, program name, TV rating, air time. In some embodiments, this information can be retrieved from an electronic program guide or remote TV listing servers. Information about recorded video content can be obtained from a recording database on the DVR. At 710, the artificial intelligence (AI) model is updated to learn user preferences based on the viewing. In addition, when updating the AI model, old viewing history can be removed from the model, such as to update the AI model for more age-appropriate content as the user ages or to account for new time commitments of the user.

Referring now to FIG. 8, an exemplary method 800 is depicted of performing content analysis, such as that which occurs at 604. At 802, a channel to analyze is determined. At 804, the content is analyzed to determine if the scheduled main content is being broadcast. If an advertisement or breaking news (e.g., a presidential address) is instead currently being displayed, then the recommendation of that channel is reduced. At 806, the video format (e.g., widescreen vs. standard format, high definition vs. standard definition) and language are determined. As a result, if the user has a high definition television, the user may have a preference for high definition content versus standard definition content. Similarly, if the user does not speak a foreign language, the user is unlikely to want to view content in languages other than English. At 808, metadata about the content on the channel is analyzed. The metadata can be retrieved, by way of example, from an electronic program guide or a remote TV listings server. The metadata allows analysis to be made of whether the program is a repeat or the length of the program. After 810, analysis of the other channels is conducted, as well as the continued analysis of this channel after a period of time (e.g., 20 seconds or a complete scan of all channels).

Although not shown, analysis of other video sources (e.g., DVDs, other video inputs, etc.) can similarly be performed. In addition, in one embodiment, analysis of channels and other video sources is conducted all the time, even when the television is off so that instant recommendations can be provided when the television is turned on.

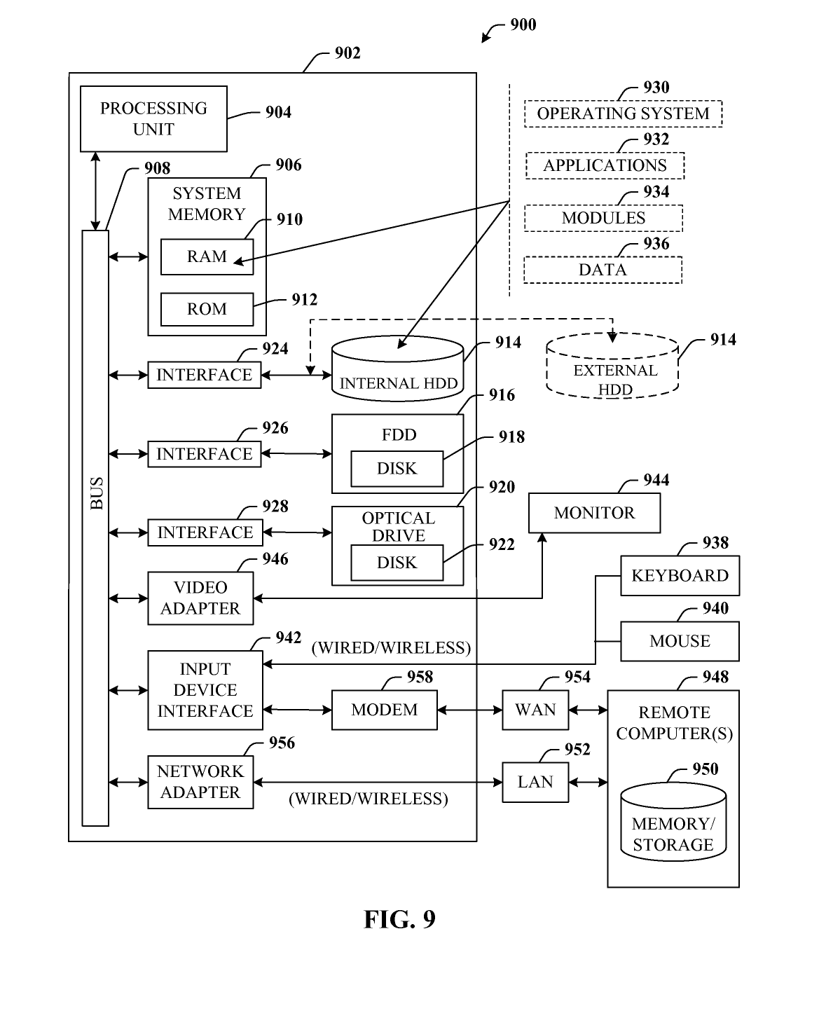

Referring now to FIG. 9, there is illustrated a block diagram of an exemplary computer system operable to execute one or more components of the disclosed system. In order to provide additional context for various aspects of the subject invention, FIG. 9 and the following discussion are intended to provide a brief, general description of a suitable computing environment 900 in which the various aspects of the invention can be implemented. Additionally, while the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention can be practiced in distributed computing environments where certain tasks are performed by remote processing devices that are linked through a communications network, such as a combination of a digital video recorder, set-top box, and television.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects of the invention includes a computer 902, the computer 902 including a processing unit 904, a system memory 906 and a system bus 908. The system bus 908 couples to system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g. reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE1394 interface technologies. Other external drive connection technologies are within contemplation of the subject invention.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a remote computers, such as a remote computer(s) 948. The remote computer(s) 948 can be a workstation, a server computer, a router, a personal computer, portable computer, microprocessor-based entertainment appliance, a peer device or other common network node, a storage device, various media gateways and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g. the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A dynamic video source surfing system, comprising:
a source evaluation component that monitors and analyzes content of each of at least a subset of available video sources not being viewed; and
a source surfing component that recommends a subset of sources not being viewed for surfing as a function of the content analysis and user preferences.

2. The system of claim 1, further comprising an artificial intelligence component that infers at least some of the user preferences.

3. The system of claim 1, wherein the user is a plurality of individual viewers.

4. The system of claim 1, wherein the available video sources are a plurality of video channels.

5. The system of claim 1, wherein at least one of the available video sources is a local station not available on a primary input source, downloaded video content, or content from a video disk.

6. The system of claim 1, the source surfing component displays an indication of the subset of the recommended sources.

7. The system of claim 1, the source evaluation component analyzing each video source to determine if an advertisement is currently being presented on a video source and altering the recommended subset based on that determination.

8. A digital video recorder employing the system of claim 1.

9. A television employing the system of claim 1.

10. A channel navigation method comprising:
monitoring and analyzing content of one or more channels not currently being viewed; and
providing a user with one or more recommended channels to currently view as a function of the content analysis and user preferences.

11. The method of claim 9, further comprising:
receiving an indication of the user; and
determining preferences of the user.

12. The method of claim 11, wherein the determining of the preferences of the users includes receiving an indication from the user of one or more preferences.

13. The method of claim 11, wherein the determining of the preferences of the user includes inferring one or more user preferences.

14. The method of claim 12, wherein inferring one or more user preferences includes inferring one or more user preference based on historical viewing patterns of the user.

15. The method of claim 10, wherein the providing a user with one or more recommended channels to currently view as a function of the content analysis and user preferences includes displaying a home page when a television is initially turned on.

16. The method of claim 10, wherein the providing a user with one or more recommended channels to currently view as a function of the content analysis and user preferences includes dynamically arranging the order channels are surfed such that access to the recommended channels is optimized.

17. The method of claim 10, wherein the monitoring and analyzing content of one or more channels not currently being viewed includes at least one of determining if the main content is currently being broadcast, determining a language of the content, determining if the content is a repeat or determining the video format of the content.

18. The method of claim 10, wherein monitoring and analyzing content of one or more channels not currently being viewed includes:
determining if the main content is currently being broadcast;
determining a language of the content;
determining if the content is a repeat; and
determining the video format of the content.

19. A computer-readable medium having computer-executable instructions for performing the method of claim 10.

20. A dynamic video source navigation system, comprising:
means for analyzing content of each of at least a subset of available video sources not being viewed;
means for recommending a subset of sources not being viewed for potential current viewing as a function of the content analysis and user preferences; and
means for presenting the recommended subset of sources to the user.
